(19) United States
(12) Patent Application Publication
(10) Pub. No.: US 2023/0253795 A1
(43) Pub. Date: Aug. 10, 2023

(54) VEHICLE

(71) Applicant: TOYOTA JIDOSHA KABUSHIKI KAISHA, Toyota-shi (JP)

(72) Inventors: Akinori MORISHIMA, Naka-gun (JP); Tohru NAKAMURA, Toyota-shi (JP)

(73) Assignee: TOYOTA JIDOSHA KABUSHIKI KAISHA, Toyota-shi (JP)

(21) Appl. No.: 18/076,782

(22) Filed: Dec. 7, 2022

(30) Foreign Application Priority Data
Feb. 9, 2022 (JP) 2022-018663

(51) Int. Cl. H02J 3/32; B60L 55/00; B60L 58/12; B60L 50/60; H02J 7/00

(52) U.S. Cl. CPC H02J 3/322; B60L 55/00; B60L 58/12; B60L 50/60; H02J 7/0048; H02J 7/00712

(57) ABSTRACT

A vehicle is a vehicle that is capable of participating in demand response (DR) for adjustment of electricity supply-demand balance in an electric power grid. The vehicle includes an MG, an inlet, a battery, and an ECU. The ECU performs SOC lowering control that controls the MG in such a manner that when the vehicle participates in down DR at a travel end point of the vehicle where an electricity facility is installed, a travel end SOC, which is a SOC of the battery at the travel end point, becomes lower than when the vehicle does not participate in down DR at the travel end point.

### CROSS-REFERENCE TO RELATED APPLICATION

This application claims priority to Japanese Patent Application No. 2022-018663 filed on Feb. 9, 2022, incorporated herein by reference in its entirety.

### BACKGROUND

### 1. Technical Field

The present disclosure relates to a vehicle and, more particularly, to a vehicle including an electricity storage device.

### 2. Description of Related Art

Japanese Unexamined Patent Application Publication No. 2020-150717 (JP 2020-150717 A) discloses an electrified vehicle that can connect to an electric power grid. The electrified vehicle includes a secondary battery, a vehicle electronic control unit (ECU), and a state-of-charge (SOC) adjustment means for adjusting SOC of a secondary battery. The vehicle ECU controls a travel state of the electrified vehicle. When a predicted amount of electricity supply is larger than a predicted amount of electricity demand in the electric power grid, the SOC adjustment means outputs an operation instruction to the vehicle ECU such that the SOC is lowered. When the predicted amount of electricity demand is larger than the predicted amount of electricity supply, the SOC adjustment means outputs an operation instruction to the vehicle ECU such that the SOC is increased. The electrified vehicle is configured to be capable of both discharging electricity from the electricity storage device into the electric power grid, and charging the electricity storage device with electricity from the electric power grid.

### SUMMARY

In a virtual power plant (VPP), demand response (DR) for adjustment of electricity supply-demand balance is considered. DR is a mechanism for issuing a request to an electricity resource of a demander to change (for example, decrease) demand for electricity.

When vehicles including an electricity storage device are used for electricity resources in DR, a case is conceivable where, of discharging electricity from the electricity storage device of a vehicle into the electric power grid, and charging the electricity storage device with electricity from the electric power grid, only the charging is possible (for example, a case where a vehicle is only able to charge the electricity storage device with electricity from the electric power grid). JP 2020-150717 A does not consider a technique for a vehicle to contribute to adjustment of electricity supply-demand balance even in such a case.

The present disclosure has been made to solve the problem as described above, and an object thereof is that a vehicle including an electricity storage device contributes to adjustment of electricity supply-demand balance in an electric power grid when only charging is possible for the vehicle, of discharging electricity from the electricity storage device into the electric power grid and charging the electricity storage device with electricity from the electric power grid.

A vehicle according to the present disclosure is a vehicle that is capable of participating in DR for adjustment of electricity supply-demand balance in an electric power grid. The vehicle includes an electric load, an electricity reception device, an electricity storage device, and a control device. The electricity reception device is configured to receive electricity from the electric power grid via an electricity facility installed outside of the vehicle. The electricity storage device stores the electricity received by the electricity reception device. The control device controls the electric load and charging of the electricity storage device. The control device is configured to perform external charging that charges the electricity storage device by using the electricity reception device. The DR includes down DR that requests that the vehicle decrease an amount of charge of the electricity storage device in the external charging when the vehicle participates in the DR. The control device performs SOC lowering control that controls the electric load in such a manner that when the vehicle participates in the down DR at a travel end point of the vehicle where the electricity facility is installed, a travel end SOC becomes lower than when the vehicle does not participate in the down DR at the travel end point, the travel end SOC being a SOC of the electricity storage device at the travel end point.

When only charging is possible, of discharging electricity from the electricity storage device into the electric power grid and charging the electricity storage device with electricity from the electric power grid, and when demand for electricity is greater than supply of electricity in the electric power grid, the vehicle is required to participate in the down DR in order to contribute to adjustment of electricity supply-demand balance. With the configuration made as described above, when the vehicle participates in the down DR, an uncharged capacity of the electricity storage device at the travel end point can be increased, compared to when the vehicle does not participate in the down DR. Thus, an allowable decrease (an amount of electricity that can be cancelled) in the amount of charge originally scheduled during a period when the vehicle participates in the down DR can be increased. As a result, a greater contribution to adjustment of electricity supply-demand balance can be made.

When the vehicle does not participate in the down DR at the travel end point during a first period, the amount of charge in the external charging during the first period may be a first amount of charge. When the vehicle participates in the down DR at the travel end point during the first period, the amount of charge in the external charging during the first period may be a second amount of charge that is smaller than the first amount of charge. The control device may perform the external charging in such a manner that the electricity storage device is charged with a differential amount of electricity during a second period from an end time of the first period to a scheduled time of departure of the vehicle, the differential amount of electricity being an amount of electricity corresponding to a difference between the first amount of charge and the second amount of charge.

With the configuration made as described above, the electricity storage device is charged, during the second period, with the differential amount of electricity corresponding to an amount of electricity that is not supplied to the electricity storage device during the first period. As a result, a situation can be avoided in which the electricity storage device is not sufficiently charged at the scheduled time of departure of the vehicle.

The DR may include up DR that requests that the vehicle increase the amount of charge in the external charging. The SOC lowering control may include control of the electric load that is performed in such a manner that when the vehicle participates in the up DR at the travel end point, the travel end SOC becomes lower than when the vehicle does not participate in the up DR at the travel end point.

With the configuration made as described above, when the vehicle participates in the up DR, the uncharged capacity of the electricity storage device at the travel end point can be increased, compared to when the vehicle does not participate in the up DR. Thus, an amount of electricity that can be supplied additionally to the electricity storage device during a period when the vehicle participates in the up DR can be increased.

The electric load may include a rotating electric machine that generates driving force for travel of the vehicle by consuming the electricity stored in the electricity storage device. The SOC lowering control may include control of the rotating electric machine that is performed in such a manner that when the vehicle participates in the DR at the travel end point, an upper limit of output produced by the rotating electric machine during travel of the vehicle becomes higher than when the vehicle does not participate in the DR at the travel end point.

With the configuration made as described above, electricity consumption by the rotating electric machine during travel of the vehicle can be increased. Thus, when a user prefers the vehicle to travel powerfully, it can be made easier to lower the SOC of the electricity storage device, while the desire of the user is satisfied.

The control device may control the electric load during travel of the vehicle in such a manner that SOC of the electricity storage device does not become less than a required SOC. The required SOC may be a SOC of the electricity storage device that is required for the vehicle to travel up to a destination of the vehicle as the travel end point.

With the configuration made as described above, an event can be avoided in which the SOC lowers to such an extent that the vehicle is unable to arrive at the destination.

The control device may be configured to predict a plurality of candidates for the destination. The required SOC may be determined based on a first required SOC and a second required SOC. The first required SOC may be a SOC of the electricity storage device that is required for the vehicle to travel up to a first candidate among the plurality of candidates for the destination. The second required SOC may be a SOC of the electricity storage device that is required for the vehicle to travel up to a second candidate among the plurality of candidates for the destination, the second candidate having a longer distance from the vehicle than the first candidate.

With the configuration made as described above, both the first required SOC and the second required SOC are reflected in determination of the required SOC. Thus, when the vehicle travels up to the second candidate, an event can be avoided in which the SOC of the electricity storage device excessively lowers.

The electric load may include an accessory machine that operates by consuming the electricity stored in the electricity storage device. The SOC lowering control may include control of the accessory machine that is performed in such a manner that when the vehicle participates in the DR at the travel end point, electricity consumption by the accessory machine increases, compared to when the vehicle does not participate in the DR at the travel end point.

With the configuration made as described above, electricity consumption by the accessory machine can be increased. Thus, while the user sufficiently enjoys a function of the accessory machine, it can be made easier to lower the SOC of the electricity storage device.

The electric load may include an accessory machine that operates by consuming the electricity stored in the electricity storage device. The SOC lowering control may include control of the accessory machine that is performed in such a manner that when the vehicle participates in the DR at the travel end point, the accessory machine starts operating before a scheduled time of travel start of the vehicle.

With the configuration made as described above, while the user immediately enjoys a function of the accessory machine when the user rides the vehicle, it can be made easier to lower the SOC of the electricity storage device.

The electric load may include a generator that is configured to perform regenerative electricity generation in connection with braking of the vehicle. Regenerative electricity that is electricity generated by the regenerative electricity generation may be supplied from the generator to the electricity storage device. The SOC lowering control may include control of the generator that is performed in such a manner that when the vehicle participates in the down DR at the travel end point, the regenerative electricity during travel of the vehicle is decreased, compared to when the vehicle does not participate in the down DR at the travel end point.

With the configuration made as described above, an event is avoided in which the SOC is unnecessarily increased due to regenerative electricity generation. As a result, it can be made easier to lower the SOC.

The control device may start the SOC lowering control when a preceding time comes, the preceding time being a time a threshold period of time before a scheduled time of travel end that is a time at which the vehicle is scheduled to arrive at the travel end point.

With the configuration made as described above, the SOC lowering control is not performed before the preceding time comes. Thus, an event can be avoided in which the SOC of the electricity storage device unnecessarily lowers.

The control device may start the SOC lowering control when a distance from the vehicle to the travel end point decreases to a threshold distance.

With the configuration made as described above, the SOC lowering control is not performed before the distance from the vehicle to the travel end point decreases to the threshold distance. Thus, an event can be avoided in which the SOC of the electricity storage device unnecessarily lowers.

The control device may perform the SOC lowering control when the electricity facility is able to perform, of discharging processing and charging processing, only the charging processing, the discharging processing causing the electricity stored in the electricity storage device to be discharged into the electric power grid via the electricity facility, the charging processing causing the control device to perform the external charging by using electricity from the electric power grid.

With the configuration made as described above, when the electricity facility is not configured to be capable of the discharging processing, of the charging processing and the discharging processing, the travel end SOC becomes low. As a result, while the user can deal with such a case, a contribution to adjustment of electricity supply-demand balance can be made.

The vehicle may include a V1G vehicle configured to perform only the external charging, of external discharging and the external charging, the external discharging discharging the electricity stored in the electricity storage device into the electric power grid via the electricity facility.

With the configuration made as described above, while the configuration and control of the vehicle are simplified, a contribution to adjustment of electricity supply-demand balance can be made.

According to the present disclosure, when only charging is possible for a vehicle including an electricity storage device, of discharging electricity from the electricity storage device into an electric power grid and charging the electricity storage device with electricity from the electric power grid, the vehicle can contribute to adjustment of electricity supply-demand balance in the electric power grid.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows a schematic configuration of an electricity management system according to an embodiment;

FIG. 2 schematically shows an example of a configuration of a vehicle;

FIG. 3 shows a situation where vehicles are electrically connected to electricity facilities;

FIG. 4 shows an example of data stored in a storage device of a server;

FIG. 5 is a diagram for describing changes over time in SOC of a battery for travel of a V1G vehicle when the vehicle participates in DR at a travel end point;

FIG. 6 is a diagram for describing changes over time in battery SOC when a vehicle participates in down DR at a travel end point, in the present embodiment;

FIG. 7 is a diagram for describing that “required value of torque-vehicle speed characteristic” changes according to whether or not a vehicle participates in down DR;

FIG. 8 is a diagram for describing changes over time in battery SOC when a vehicle participates in DR at a travel end point;

FIG. 9 shows a relationship between the distance from a current position of a vehicle to a destination and a required SOC;

FIG. 10 is a diagram for describing relationships between an upper limit of regenerative electricity and an extra amount of electricity, and between an upper limit of electricity consumption by an electric load and the extra amount of electricity;

FIG. 11 is a flowchart showing an example of processing performed by an ECU, according to the first embodiment;

FIG. 12 is a flowchart showing another example of processing performed by the ECU, according to the first embodiment;

FIG. 13 is a flowchart showing an example of processing performed by the ECU, according to a modification 1 of the first embodiment;

FIG. 14 is a flowchart showing an example of processing performed by the ECU, according to a modification 2 of the first embodiment; and

FIG. 15 is a diagram for describing how the required SOC is determined when the number of candidates for a destination is two.

### DETAILED DESCRIPTION OF EMBODIMENTS

Hereinafter, embodiments of the present disclosure are described in detail with reference to the drawings. In the drawings, the same or similar portions are denoted by the same signs, and a description thereof is not repeated.

First Embodiment

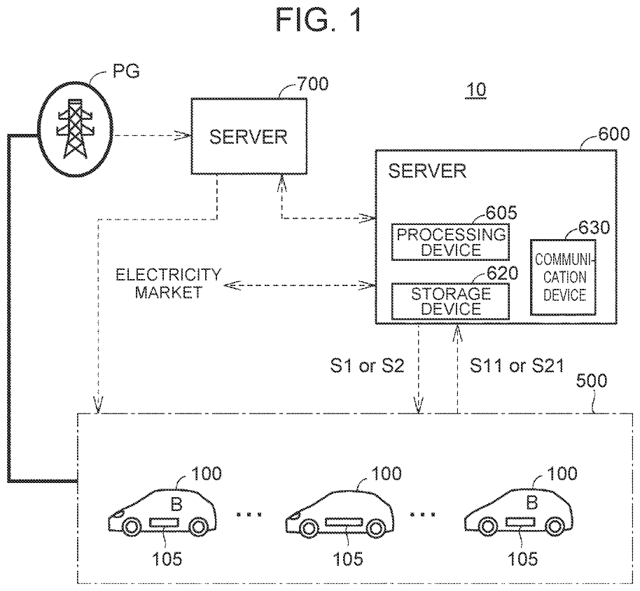

FIG. 1 shows a schematic configuration of an electricity management system according to a first embodiment. Referring to FIG. 1, the electricity management system 10 includes an electric power grid PG, electricity resources 500, a server 600, and a server 700.

The electric power grid PG is built by using transmission and distribution equipment. The electric power grid PG is maintained and managed by an electricity utility company that is an operator of the electric power grid PG.

The electricity resources 500 include a plurality of vehicles 100, each equipped with a battery 105. Each vehicle 100 is configured to be electrically connectable to the electric power grid PG, and is a battery electric vehicle (BEV) that functions as a distributed power supply. The electricity resources 500 may further include another electricity storage system that is different from the vehicles 100, such as a home energy management service (HEMS).

Each vehicle 100 is configured to be capable of external charging, in which the battery 105 is charged by using electricity supplied from an electricity facility installed outside of the vehicle. When each vehicle 100 performs external charging, an electricity load in the electric power grid PG increases because electricity is supplied from the electric power grid PG to each vehicle 100. As described above, each vehicle 100 can participate in DR by performing external charging.

For example, when a vehicle 100 participates in DR, external charging may be performed in response to “up DR”, which requests that the vehicle 100 increase the amount of charge in the external charging. In such a case, demand for electricity in the electric power grid PG can be increased by an additional amount of electricity. Up DR is performed when supply of electricity in the electric power grid PG is greater than demand for electricity.

On the other hand, when a vehicle 100 participates in DR, the amount of charge may be decreased in response to “down DR”, which requests that the vehicle 100 decrease (save) the amount of charge in external charging. In such a case, demand for electricity in the electric power grid PG is decreased (cancelled) by a decrease made in the amount of charge. Down DR is performed when demand for electricity in the electric power grid PG is greater than supply of electricity.

The server 600 is a computer belonging to an aggregator and is configured to manage the electricity resources 500. The aggregator is an electricity business operator that procures electricity for the electric power grid PG by using the electricity resources 500.

The server 600 includes a processing device 605, a communication device 630, and a storage device 620. The processing device 605 includes a processor and a memory. The communication device 630 includes various communication interfaces. The storage device 620 stores, for example, a program to be executed by the processing device 605, and various information to be used by the processing device 605.

The server 600 is configured to predict electricity supply-demand balance in the electric power grid PG for each period (period of day), and to issue a DR request to the vehicles 100 in accordance with a result of the prediction. Specifically, the server 600 is configured to send a down DR signal S1 or an up DR signal S2 to the vehicles 100. The down DR signal S1 and the up DR signal S2 are signals to request down DR and up DR from the vehicles 100, respectively. Each of the down DR signal S I and the up DR signal S2 includes information indicating a period for which DR is performed (DR period), and an amount of electricity that is transferred between a vehicle 100 and the electric power grid PG (amount of transferred electricity) during the period. The signals may further include information on an electricity facility used by a vehicle 100 for DR (hereinafter, also referred to as “facility for DR participation”) (for example, an ID of and position information on the facility).

The server 600 is configured to receive an approval signal S11 or an approval signal S21 from the vehicles 100. The approval signal S11 and the approval signal S21 are sent from each vehicle 100 to the server 600 in response to the down DR signal S1 and the up DR signal S2, respectively. The approval signal S11 and the approval signal S21 indicate that a user of a vehicle 100 approves of the vehicle 100 participating in down DR and up DR, respectively.

When the server 600 receives the approval signal S11 or the approval signal S21, an agreement is established between the user of the vehicle 100 and the aggregator. The agreement includes information indicating a DR period (a beginning time and an end time of the DR period), a DR category (whether DR is down DR or up DR), an amount of transferred electricity (for example, an amount of charge) during the DR period, and a consideration (reward) to be paid by the aggregator to the user.

Agreement information indicating the content of the agreement is included in the approval signal S11 or the approval signal S21, and is also stored in a storage device of the vehicle 100. The agreement information may further include information indicating a facility for DR participation, and information indicating whether or not the agreement is a V1G agreement. The “V1G agreement” is an agreement that allows a vehicle to participate in

DR by only receiving electricity from the electric power grid PG, without supplying (discharging) electricity stored in the battery of the vehicle to the electric power grid PG.

When the vehicle 100 participates in down DR or up DR, the user can gain a reward from the aggregator, according to an amount of electricity that can be cancelled from an amount of charge originally scheduled during the DR period, or an amount of electricity that can be consumed in excess of the originally scheduled amount of charge (negawatt trading or posiwatt trading), respectively.

The server 700 is a computer belonging to an electricity utility company and is configured to be communicable with the server 600. The server 700 outputs, for example, a request to the server 600 such that an amount of electricity for adjusting electricity supply-demand balance in the electric power grid PG is procured to the electric power grid PG.

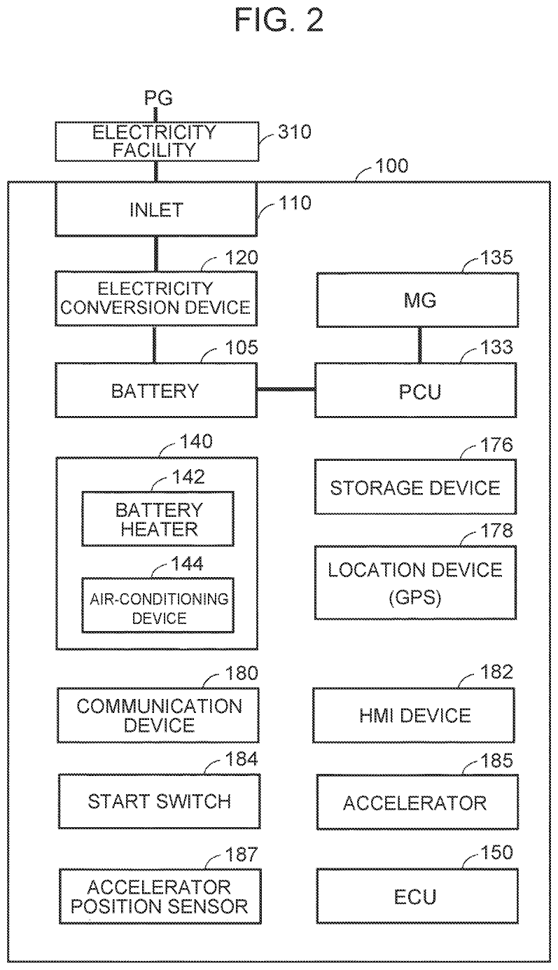

FIG. 2 schematically shows an example of a configuration of a vehicle 100. The vehicle 100 includes an inlet 110, an electricity conversion device 120, a power control unit (PCU) 133, and a motor generator (MG) 135, in addition to the battery 105. The vehicle 100 further includes accessory machines 140, a storage device 176, a location device 178, a communication device 180, and a human machine interface (HMI) device 182. The vehicle 100 still further includes a start switch 184, an accelerator 185, an accelerator position sensor 187, and an ECU 150.

The battery 105 is an electricity storage device that stores electricity for travel, and is a secondary battery such as a lithium-ion battery or a nickel metal hydride battery. The battery 105 is configured to store electricity received by the inlet 110. A SOC of the battery 105 corresponds to an amount of electricity stored in the battery 105. The battery 105 may be substituted by another electricity storage device such as an electric double-layer capacitor.

The inlet 110 is an electricity reception device configured to receive electricity from the electric power grid PG via an electricity facility 310 that is installed outside of the vehicle 100. The inlet 110 may be substituted by an electricity reception device compliant with a non-contact charging scheme.

The electricity conversion device 120 is provided between the battery 105 and the inlet 110. The electricity conversion device 120 converts electricity received by the inlet 110 and supplies the electricity after conversion to the battery 105. Thus, external charging by the vehicle 100 is performed. The electricity conversion device 120 is a unidirectional electricity conversion device that is not configured to be capable of converting electricity stored in the battery 105 and outputting the electricity to the inlet 110. Accordingly, of charging the battery 105 with electricity from the electric power grid PG (external charging) and discharging electricity from the battery 105 into the electric power grid PG via the electricity facility 310 (external discharging), the vehicle 100 is a vehicle that is capable of only the external charging. Such a vehicle is also referred to as V1G vehicle. On the other hand, a vehicle that is capable of both the external charging and the external discharging is also referred to as V2G vehicle.

The PCU 133 is a drive device for driving the MG 135 (described later). The PCU 133 includes an inverter. The PCU 133 converts direct current output from the battery 105 into alternating current, and drives the MG 135 by using the alternating current after conversion. The PCU 133 is also configured to convert alternating current generated by the motor generator MG 135 when the vehicle 100 is braked, into direct current.

The MG 135 is an electric load mounted in the vehicle 100 and is, for example, a three-phase alternating-current synchronous motor with permanent magnet embedded in a rotor. The MG 135 is configured to generate driving force (torque) for travel of the vehicle 100 by consuming electricity stored in the battery 105. The driving force generated by the MG 135 is transmitted to a driving wheel of the vehicle 100. Thus, the vehicle 100 travels. The larger the driving force for travel of the vehicle 100 is, or the higher the travel speed (vehicle speed) of the vehicle 100 is, the more electricity the MG 135 consumes. The MG 135 can also function as a generator that generates electricity by using rotating force of the driving wheel when the vehicle 100 is braked (regenerative electricity generation). Regenerative electricity that is electricity generated by the regenerative electricity generation is supplied (charged) to the battery 105 via the PCU 133.

The accessory machines 140 include a battery heater 142 and an air-conditioning device 144. The battery heater 142 is provided in vicinity of the battery 105 and is configured to heat the battery 105. The air-conditioning device 144 is configured to adjust temperature within a vehicle cabin of the vehicle 100, and includes a heating function and a cooling function. Each of the battery heater 142 and the air-conditioning device 144 is an electric load mounted in the vehicle 100, and is an accessory machine that operates by consuming electricity stored in the battery 105.

The storage device 176 stores a program and data (for example, electricity mileage of the vehicle 100, and whether the vehicle 100 is a V1G vehicle or a V2G vehicle) that are used by the ECU 150 (described later), as well as information input into the HMI device 182 (described later). The storage device 176 may further include a road information database and a history of user behavior of the vehicle 100 (for example, a history of changes over time in position of the vehicle 100).

The location device 178 detects information indicating a current position of the vehicle 100 (for example, a longitude and a latitude of the current position) by using a global positioning system (GPS). A history of the information detected by the location device 178 may be stored in the storage device 176.

The communication device 180 is configured to communicate with external equipment such as the server 600 (FIG. 1), via a communication network such as the Internet. For example, the communication device 180 is configured to receive a down DR signal S1 or an up DR signal S2 from the server 600, and to send an approval signal S11 or an approval signal S21 to the server 600.

The HMI device 182 is, for example, a touch screen. The HMI device 182 receives an operation made by a user and displays various information to the user.

For example, the HMI device 182 receives user operations for setting a destination of the vehicle 100, a schedule of external charging, and a scheduled time of departure of the vehicle 100 (described later).

The start switch 184 is pressed by the user. When the start switch 184 is pressed, a system for travel of the vehicle 100 (power supply system) is started, and the vehicle 100 falls in a state ready for travel.

The accelerator 185 is provided on a driver side. The accelerator position sensor 187 detects an amount of operation of the accelerator 185 performed by the user (accelerator operation amount), and outputs a detected value of the accelerator operation amount to the ECU 150.

The ECU 150 includes a central processing unit (CPU) and a memory (neither are shown). The memory includes a read only memory (ROM) and a random access memory (RAM).

The ECU 150 controls each device of the vehicle 100, such as the electricity conversion device 120, the PCU 133, the MG 135, the accessory machines 140, the HMI device 182, and the communication device 180. For example, the ECU 150 is configured to control charging of the battery 105. The ECU 150 is configured to be capable of external charging in which the battery 105 is charged by using electricity received by the inlet 110.

When the communication device 180 receives a down DR signal S1 or an up DR signal S2, the ECU 150 inquires of the user, by using the HMI device 182, whether or not the vehicle 100 participates in DR corresponding to the signal. When a user operation indicating that the vehicle 100 participates in down DR or up DR is input into the HMI device 182, the ECU 150 sends an approval signal S11 or an approval signal S21 to the server 600 via the communication device 180.

The ECU 150 calculates a required value of torque of the vehicle 100, based on the detected value (accelerator operation amount) from the accelerator position sensor 187. The ECU 150 calculates the required value of torque, for example, based on a map indicating a relationship between the accelerator operation amount and the required value of torque, and on the detected value from the accelerator position sensor 187. The map is stored in the storage device 176. When the required value of torque is less than a threshold torque while the vehicle 100 is traveling, the ECU 150 controls the PCU 133 in such a manner that torque corresponding to the required value of torque is output by the MG 135. When the required value of torque exceeds the threshold torque while the vehicle 100 is traveling, the ECU 150 controls the PCU 133 in such a manner that the threshold torque is output by the MG 135.

When a destination of the vehicle 100 is set, the ECU 150 is configured to calculate a scheduled time of travel end that is a time at which the vehicle 100 is scheduled to arrive at a travel end point as the destination. The ECU 150 determines a travel route from a current position of the vehicle 100 up to the destination of the vehicle 100, based on the road information database stored in the storage device 176, the current position, and the destination, and calculates the scheduled time of travel end, based on a result of the determination.

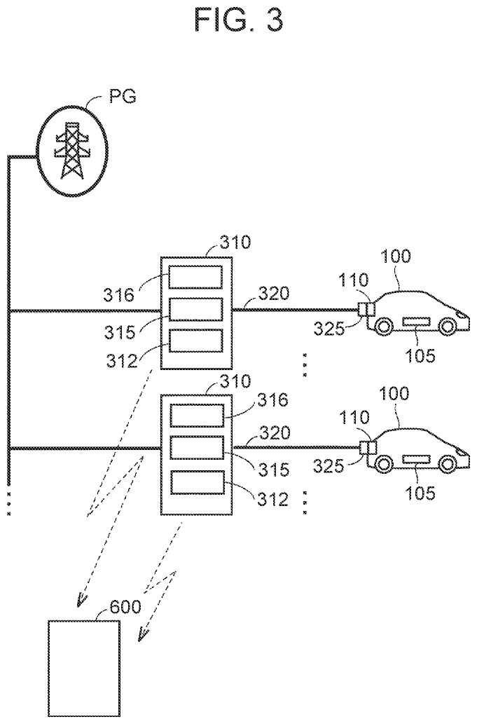

FIG. 3 shows a situation where the vehicles 100 are electrically connected to the electricity facilities 310. Referring to FIG. 3, each electricity facility 310 includes a communication device 312, an electricity conversion device 315, and a control device 316.

The communication device 312 is configured to be communicable with the server 600. The electricity conversion device 315 is configured to convert electricity supplied from the electric power grid PG, and to supply the electricity after conversion to the vehicle 100 through an electricity cable 320 and a connector 325 of the electricity cable 320. The electricity conversion device 315 is not configured to convert electricity supplied to the electricity facility 310 from an electricity resource (for example, a vehicle) connected to the electricity facility 310 and supply the electricity after conversion to the electric power grid PG. Since the electricity conversion device 315 is a unidirectional electricity conversion device as described above, similarly to the electricity conversion device 120 of the vehicles 100, the electricity facilities 310 are dedicated for external charging, of external discharging and external charging.

When the connector 325 is connected to the inlet 110, the control device 316 can perform charging processing of outputting a request to start external charging to the vehicle 100 and thereby causing the ECU 150 to perform external charging by using electricity from the electric power grid PG. On the other hand, the control device 316 is not configured to perform discharging processing of causing electricity stored in the battery 105 to be discharged into the electric power grid PG via the electricity facility 310.

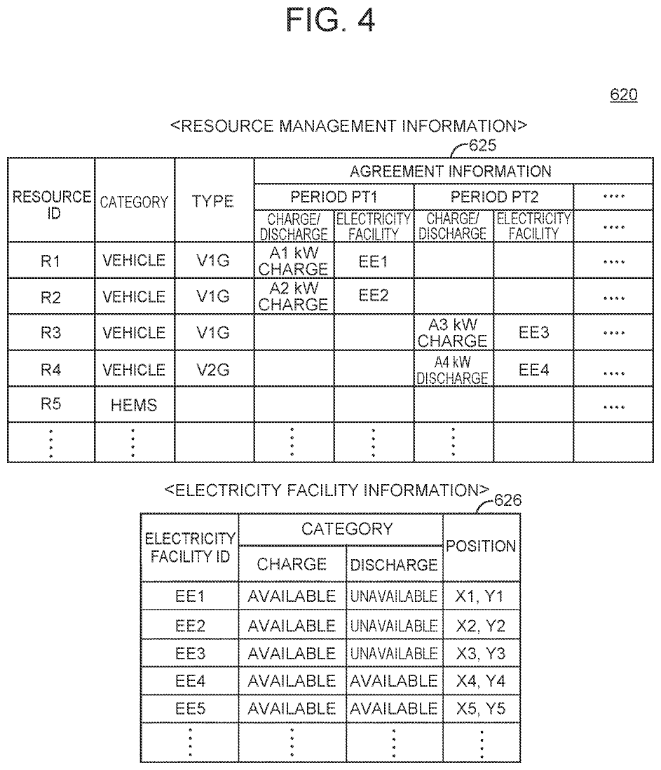

FIG. 4 shows an example of data stored in the storage device 620 of the server 600. Referring to FIG. 4, the storage device 620 stores a resource management information table (a list pattern) 625 and an electricity facility information table 626.

The resource management information table 625 indicates various information on an electricity resource, for each resource ID. “Resource ID” is identification information assigned to each electricity resource.

“Category” indicates a category of an electricity resource. In the example, electricity resources with IDs of R1 to R4 are vehicles. An electricity resource with an ID of R5 is a HEMS.

“Type” indicates, when an electricity resource is classified as a vehicle under category, whether the vehicle is a V2G vehicle or a V1G vehicle. In the example, the vehicles with IDs of R1 to R3 are V1G vehicles like the vehicles 100. The vehicle with an ID of R4 is a V2G vehicle.

“Agreement information” indicates how each electricity resource participates in DR under an agreement, for each period. Each period is a period during which an electricity resource is able to participate in DR. The length of each period is, for example, but is not limited to, 30 minutes. In the example, the vehicle with an ID of R1 performs external charging during a period PT1 by using an electricity facility EE1 in such a manner that the battery of the vehicle is charged with an amount A1 of electricity from the electric power grid PG. The vehicle with an ID of R4 performs battery discharging control during a period PT2 by using an electricity facility EE4 in such a manner that an amount A4 of electricity is discharged from the battery of the vehicle into the electric power grid PG.

When the vehicle with an ID of R1 participates in up DR or down DR (specifically, when an approval signal S21 or an approval signal S11 is received from the vehicle), the server 600 rewrites the resource management information table 625 in such a manner that the amount of charge (for example, A1) for the vehicle during a period of the DR is increased or decreased.

The electricity facility information table 626 indicates various information on an electricity facility, for each facility ID. “Facility ID” is identification information assigned to each electricity facility.

“Category” indicates a category of an electricity facility. In the example, electricity facilities with IDs of EE1 to EE3 are used only for external charging, of external charging and external discharging, similarly to the electricity facilities 310. Electricity facilities with IDs of EE4, EE5 can be used for both of external charging and external discharging. “Position” indicates a position (for example, a latitude and a longitude) of an electricity facility.

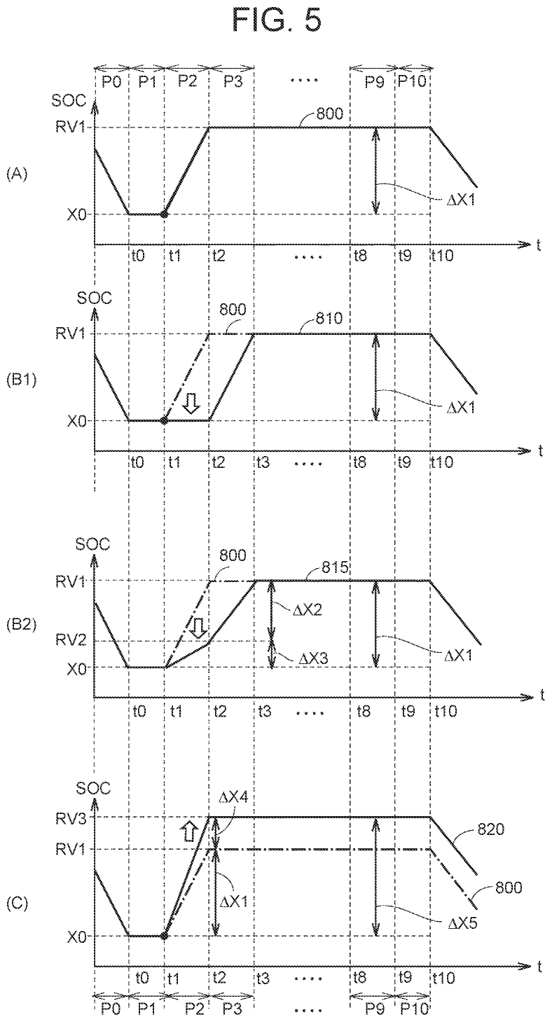

FIG. 5 is a diagram for describing changes over time in SOC of a battery for travel of a V1G vehicle when the vehicle participates in DR at a travel end point. The travel end point is, for example, a parking space in a home of a user of the vehicle. In the first embodiment, an electricity facility 310 is installed at the travel end point. In the example, a comparison example is shown in which control by the ECU 150, which will be described later, is not performed.

Referring to FIG. 5, a line 800 shows an example of changes in battery SOC when the V1G vehicle in the comparison example performs external charging after finishing traveling (case A).

In the example, a schedule of external charging is arranged in such a manner that an amount of electricity (first amount of charge) corresponding to ΔX1 is supplied (charged) during period P2 from the electric power grid PG to the battery of the vehicle. In the case A in the comparison example, the vehicle does not participate in DR (including up DR and down DR).

During period PO before time t0, the vehicle is traveling, and the SOC decreases with travel of the vehicle. When the vehicle finishes traveling at time t0, the connector 325 of the electricity cable 320 (FIG. 3) is connected to the inlet of the vehicle by the user. In the comparison example, a travel end SOC, which is a SOC at the travel end point, is X0.

When time t1 comes, the vehicle performs external charging (period P2). When the SOC reaches RV1 at time t2, external charging is finished. Thus, the battery is charged with the amount of electricity corresponding to ΔX1. For example, when a destination after the vehicle starts traveling is set, RV1 is a reference value determined as a minimum required SOC for the vehicle to travel up to the destination. The ECU 150 determines RV1, based on the electricity mileage of the vehicle, and the distance from a current position of the vehicle to the destination.

Thereafter, the vehicle departs to travel at time t10 after a state where the SOC is RV1 continues (for example, periods P8, P9). Time t10 is a scheduled time of departure of the vehicle. Thereafter, the SOC decreases with travel of the vehicle.

A line 810 shows an example of changes in battery SOC when the V1G vehicle participates in down DR at the travel end point (case B1).

In the example, it is assumed that the vehicle has received a down DR signal S1 and has sent an approval signal S11 to the server 600 before time t11. It is assumed that the down DR signal S1 requests that the vehicle decrease (save) the amount of electricity with which the battery is to be charged through external charging during period P2, by the amount of electricity corresponding to ΔX1.

During period P2, the amount of charge in external charging of the vehicle is decreased by the amount of electricity corresponding to ΔX1, compared to the case A. In the example, since external charging is cancelled, the amount of charge is zero, and the SOC is unchanged. In other words, although the battery of the vehicle is originally scheduled to be charged with the amount of electricity corresponding to ΔX1 during period P2, the battery is not charged at all. Thus, an event is avoided in which the amount of electricity corresponding to ΔX1 is supplied from the electric power grid PG to the vehicle. In other words, a decrease of an electricity load equivalent to the amount of electricity corresponding to ΔX1 occurs in the electric power grid PG.

Thereafter, before time t9 comes (in the example, during period P3), external charging of the vehicle is performed in such a manner that the battery is charged with the amount of electricity corresponding to ΔX1. Thus, the SOC increases to RV1.

A line 815 indicates another example of changes in battery SOC when the V1G vehicle participates in down DR at the travel end point (case B2).

The line 815 is different from the line 810 in a point that the amount of charge during period P2 is decreased by an amount of electricity corresponding to ΔX2 that is smaller than ΔX1. In the example, during period P2, the SOC increases by ΔX3 from X0 (increases to RV2). Thereafter, before time t9 (or time t10) comes (in the example, during period P3), external charging is performed in such a manner that the battery is charged with the amount of electricity corresponding to ΔX2. Thus, the SOC increases to RV1. When ΔX2 (0<ΔX2≤ΔX1) is equal to ΔX1, or in other words, when ΔX3 is zero (when RV2 is equal to X0), the line 815 coincides with the line 810.

A line 820 shows an example of changes in battery SOC when the V1G vehicle participates in up DR at the travel end point (case C).

In the example, it is assumed that the vehicle has received an up DR signal S2 and has sent an approval signal S21 to the server 600 before time t1. It is assumed that the up DR signal S2 requests that the vehicle increase the amount of electricity with which the battery is charged through external charging during period P2, by an amount of electricity corresponding to ΔX4, compared to the case A.

Thus, the battery is charged with an amount of electricity corresponding to ΔX5 (=ΔX1+ΔX4) during period P2. As a result, the SOC increases to RV3. RV3 is, for example, a SOC when the battery is fully charged.

As described above, the V1G vehicle is configured to decrease (cases B1, B2) or increase (case C) the amount of charge during a DR period when the V1G vehicle participates in down DR or up DR, respectively.

When the V1G vehicle participates in down DR or up DR at the travel end point, it is preferable that an uncharged capacity of the battery at the travel end point be increased to an extent possible. The uncharged capacity of the battery is equivalent to an amount of electricity with which the battery can be charged. Such an amount of electricity corresponds to ΔX1 (cases B1, B2) or ΔX5 (case C).

For example, when the vehicle participates in down DR, the larger ΔX1 is, the larger ΔX2 can be made (case B2). Thus, a negawatt amount can be increased because an allowable decrease (an amount of electricity that can be cancelled: corresponding to ΔX2) in the amount of charge originally scheduled as an amount of electricity to be supplied from the electric power grid PG to the battery of the vehicle can be increased. As a result, the user of the vehicle can gain more reward from the aggregator, as a consideration for down DR.

When the vehicle participates in up DR, the larger ΔX5 is, the larger ΔX4 can be made. Thus, a posiwatt amount can be increased because a more amount of electricity than the amount of electricity originally scheduled as an amount of electricity to be supplied from the vehicle to the electric power grid PG can be supplied to the battery 105 additionally. As a result, the user of the vehicle can gain more reward from the aggregator, as a consideration for up DR.

When a V1G vehicle is used for an electricity resource, only external charging, of external discharging and external charging, is possible. When only external charging is possible as described above, it is important that the vehicle contribute to adjustment of electricity supply-demand balance in the electric power grid PG.

The ECU 150 of each vehicle 100 according to the present embodiment includes a configuration for contributing to adjustment of electricity supply-demand balance in such cases. Specifically, the ECU 150 controls an electric load in such a manner that when the vehicle 100 participates in down DR at a travel end point of the vehicle 100 where an electricity facility 310 is installed, the travel end SOC, which is a SOC of the battery 105 at the travel end point, becomes lower than when the vehicle 100 does not participate in down DR at the travel end point. The electric load is, for example, the MG 135, or an accessary machine such as the battery heater 142 or the air-conditioning device 144. Hereinafter, such control of an electric load by the ECU 150 is also referred to as “SOC lowering control”.

When only external charging, of external charging and external discharging, is possible, and when demand for electricity is greater than supply of electricity in the electric power grid PG, a vehicle 100 is required to participate in down DR in order to contribute to adjustment of electricity supply-demand balance. With the configuration as described above, when the vehicle participates in down DR, the uncharged capacity of the battery 105 at the travel end point can be increased, compared to when the vehicle does not participate in down DR. Thus, an allowable decrease (an amount of electricity that can be cancelled) in the amount of charge originally scheduled during a period when the vehicle participates in down DR can be increased. Hereinafter, the SOC lowering control by the ECU 150 is described in detail.

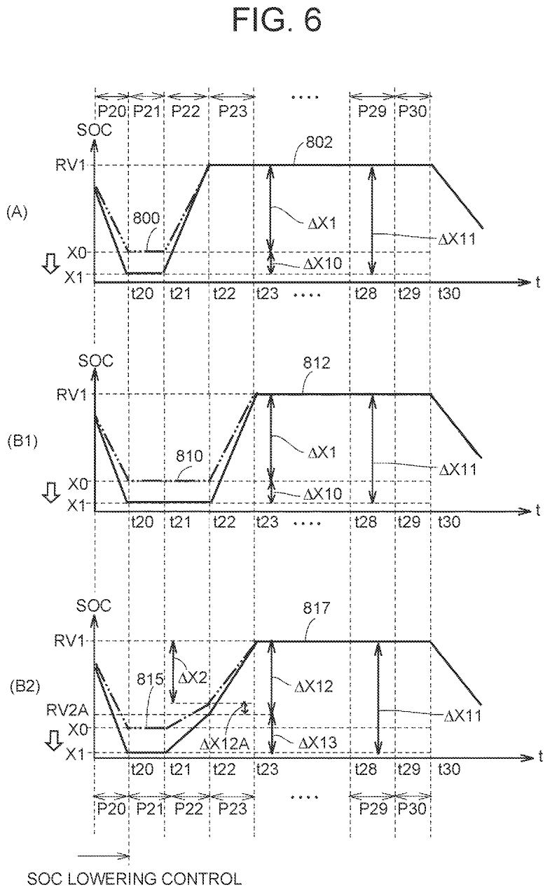

FIG. 6 is a diagram for describing changes over time in SOC of the battery 105 when a vehicle 100 participates in down DR at a travel end point, in the present embodiment.

Referring to FIG. 6, a line 802 shows an example of changes in battery SOC when the vehicle 100 is scheduled to perform external charging after finishing traveling (case A). The line 802 indicates a schedule of the external charging that is originally arranged before the vehicle 100 receives a down DR signal S 1.

Lines 812, 817 show examples of changes in battery SOC when the vehicle 100 participates in down DR at the travel end point (cases B1, B2).

The lines 802, 812, 817 are different from the lines 800, 810, 815 in the comparison example (FIG. 5), respectively, in a point that the travel end SOC is X1 (<X0). Times t20 to t30 and periods P20 to P30 are identical to times t0 to 00 and periods P0 to P10 in the comparison example, respectively.

The ECU 150 performs SOC lowering control while the vehicle 100 is traveling (for example, during period P20). In the example, the ECU 150 controls the MG 135 in such a manner that an upper limit of output produced by the MG 135, while the vehicle 100 is traveling, becomes higher than when the vehicle 100 does not participate in DR at the travel end point (the case A in FIG. 5). The output produced by the MG 135 is torque output by the MG 135, or vehicle speed when the vehicle 100 is driven with the torque.

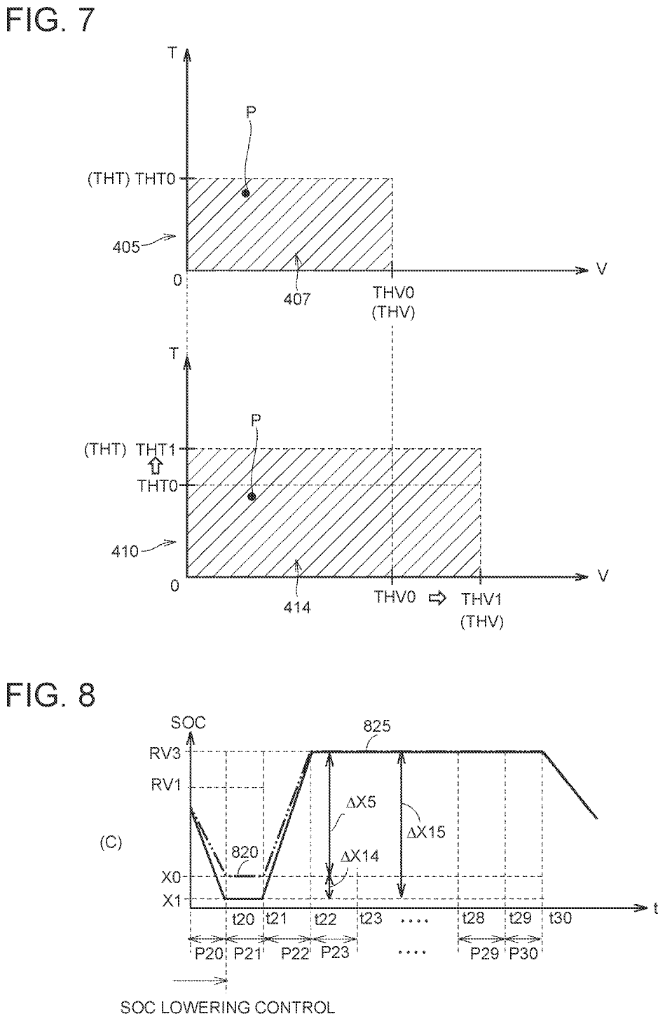

FIG. 7 is a diagram for describing that “required value of torque-vehicle speed characteristic” changes according to whether or not the vehicle 100 participates in down DR. Hereinafter, the required value of torque-vehicle speed characteristic is also referred to as T-V characteristic.

Referring to FIG. 7, a T-V characteristic 405 represents a T-V characteristic when the vehicle 100 does not participate in down DR. An area (hatched area) 407 of the T-V characteristic 405 is an area in which vehicle speeds V are less than a threshold speed THV0 (threshold speed THV), and required values of torque T are less than a threshold torque THT0 (threshold torque THT).

When coordinates of a point P, which is determined by a combination of a vehicle speed V and a required value of torque T, are within the area 407, the ECU 150 controls the MG 135 in such a manner that the vehicle 100 travels with the required value of torque T and at the vehicle speed V. When a required value of torque T exceeds the threshold torque THT, the vehicle 100 is driven not with the required value of torque T, but with the threshold torque THT.

A T-V characteristic 410 is a T-V characteristic when the vehicle 100 participates in down DR. In such a case, the ECU 150 sets the threshold torque THT and the threshold speed THV higher than when the vehicle 100 does not participate in down DR (T-V characteristic 405) (THT=THT1>THT0, THV=THV1>THV0). The ECU 150 performs processing for such settings, for example, when an approval signal S11 is sent to the server 600 via the communication device 180.

Thus, the vehicle 100 can travel with high torque that is equal to or more than the threshold torque T0, or at high speed that is equal to or more than the threshold vehicle speed THV). As a result, electricity consumption by the MG 135 can be increased. Accordingly, it can be made easier to decrease the SOC of the battery 105 before the vehicle 100 arrives at the travel end point, while, when a user prefers the vehicle 100 to travel powerfully, the appetite of the user is satisfied.

Referring back to FIG. 6, at time t20, the travel end SOC of the vehicle 100 is X1 (<X0). X1 is, for example, a value set by the user using the HMI device 182, or a default value.

In the case A, a schedule of external charging is arranged beforehand such that the vehicle 100 performs external charging during period P22 (first period). In the cases B1, B2, it is assumed that the vehicle 100 participates in down DR during period P22.

In the case B1, the vehicle 100 cancels the originally scheduled external charging (case A) during period P22. In other words, in the example, the amount of charge of the battery 105 in the external charging during period P22 is zero (line 812).

In the case B2, the amount of charge is not zero (line 817). Specifically, during period P22, the SOC increases by ΔX13 from X1 (increases to RV2A). When RV2A is equal to X1, ΔX13 is zero, ΔX12 coincides with ΔX11, and the case B2 corresponds to the case B1.

As described above, when the amount of charge is decreased to be lower than the originally scheduled amount of charge (case B1, B2), an event is avoided in which an amount of electricity corresponding to ΔX11 or ΔX12 is supplied from the electric power grid PG to the vehicle. Thus, a reduction of an electricity load corresponding to such an amount of electricity occurs in the electric power grid PG.

In the present embodiment, compared to the comparison example (FIG. 5), an allowable decrease (an amount of electricity that can be cancelled) in the amount of charge originally scheduled during the DR period (period P22) is the amount of electricity corresponding to ΔX11 (case B1) or ΔX12 (case B2). Such amounts of electricity are larger than the amounts of electricity (ΔX1, ΔX2) in the comparison example, by an amount of electricity corresponding to ΔX10 or ΔX12A, respectively. In other words, the negawatt amount can be increased.

During a period from time t23, which is an end time of period P23, to time t30, the ECU 150 performs external charging in such a manner that the battery 105 is charged with the amount of electricity corresponding to ΔX11 (case B1) or ΔX12 (case B2). Such an amount of electricity corresponds to an amount of electricity that had been originally scheduled to be supplied to the battery 105 but was not supplied to the battery 105 during period P22. Such an amount of electricity is a differential amount of electricity between the amount of electricity with which the battery 105 had been originally scheduled to be charged during period P22 (the amount of electricity corresponding to ΔX11 in the case A) and the amount of electricity supplied to the battery 105 when the vehicle 100 participates in down DR during period P22 (second amount of charge). The second amount of charge is zero in the case B1, and is the amount of electricity corresponding to ΔX13 in the case B2. The differential amount of electricity is ΔX11 in the case BI, and is ΔX12 in the case B2.

When external charging is thus performed, the battery 105 is charged with (complemented by) the differential amount of electricity during the period (second period) from time t23 to time t30. As a result, a situation can be avoided in which the battery 105 is not sufficiently charged at time t30 at which the vehicle 100 is scheduled to start traveling.

As described above, in the present embodiment, since the ECU 150 performs SOC lowering control, the travel end SOC is lower than that in the comparison example (FIG. 5) (X1<X0). As a result, the amount of electricity that can be supplied to the battery 105 in periods P21 to P30 (corresponding to ΔX11) can be made larger than the amount of electricity that can be supplied to the battery 105 in the comparison example (corresponding to ΔX1).

The ECU 150 may perform SOC lowering control when the vehicle 100 participates in up DR. Specifically, SOC lowering control may be control of an electric load such as the MG 135 that is performed in such a manner that when the vehicle 100 participates in up DR at a travel end point, the travel end SOC becomes lower than when the vehicle 100 does not participate in up DR at the travel end point.

Thus, when the vehicle 100 participates in up DR, the uncharged capacity of the battery 105 at the travel end point can be increased to be larger than when the vehicle 100 does not participate in up DR. Thus, an amount of electricity that can be supplied to the battery 105 additionally during a period when the vehicle 100 participates in up DR can be increased. Hereinafter, this is described in more detail.

FIG. 8 is a diagram for describing changes over time in SOC of the battery 105 when a vehicle 100 participates in DR at a travel end point.

Referring to FIG. 8, a line 825 shows an example changes in SOC when the vehicle 100 participates in up DR at the travel end point. The line 825 is different from the line 820 in the comparison example (FIG. 5), in a point that the travel end SOC is X1 (<X0). Times t20 to t30 and periods P20 to P30 are similar to those shown in FIG. 6.

In the example, during period P22, the battery 105 is charged with an amount of electricity corresponding to ΔX15 (=ΔX5+ΔX14). As a result, the SOC increases to RV3.

As described above, the amount of charge during period P22 (corresponding to ΔX15) is larger than the amount of charge in the comparison example (corresponding to ΔX5), by an amount of electricity corresponding to ΔX14. Accordingly, electricity supplied from the electric power grid PG to the vehicle 100 can be increased, compared to the comparison example. In other words, the posiwatt amount can be increased. As a result, an electricity load in the electric power grid PG can be made greater than that in the comparison example.

The SOC lowering control may be SOC lowering control that is performed by controlling an accessory machine in such a manner that when the vehicle 100 participates in DR at the travel end point, electricity consumption by the accessory machine is increased to be more than when the vehicle 100 does not participate in DR at the travel end point. DR may be any one of down DR and up DR.

For example, when the ECU 150 performs SOC lowering control by using the air-conditioning device 144, the ECU 150 controls the air-conditioning device 144 in such a manner that temperature in the vehicle cabin becomes higher or lower than a temperature in the vehicle set through user operation. For example, the ECU 150 may control the air-conditioning device 144 in such a manner that heating performance of the air-conditioning device 144 becomes higher in winter, or cooling performance of the air-conditioning device 144 becomes higher in summer.

When the ECU 150 performs SOC lowering control by using the battery heater 142, the ECU 150 may control the battery heater 142 in such a manner that the amount of heat generated from the battery heater 142 increases.

When the accessory machine is thus controlled, it can be made easier to lower the SOC before the vehicle 100 arrives at the travel end point, while a user sufficiently enjoys a function of the accessory machine.

The SOC lowering control may be control of the MG 135 that is performed in such a manner that when the vehicle 100 participates in down DR at the travel end point, regenerative electricity, while the vehicle 100 is traveling, is decreased to be lower than when the vehicle 100 does not participate in down DR at the travel end point. Specifically, the ECU 150 may control the PCU 133 when the vehicle 100 is braked in such a manner that regenerative electricity generated by the MG 135 is decreased.

Thus, electricity supplied (charged) from the MG 135 to the battery 105 via the PCU 133 when the vehicle 100 is braked is decreased. As a result, an event is avoided in which the SOC is unnecessarily increased due to regenerative electricity generation. Accordingly, it can be made easier to lower the SOC before the vehicle 100 arrives at the travel end point.

It is preferable that the vehicle 100 control an electric load (for example, the MG 135 or any one of the accessory machines 140) while the vehicle 100 is traveling in such a manner that the SOC of the battery 105 is not lowered to be less than a required SOC. The required SOC is a SOC that is required for the vehicle 100 to travel up to a destination as the travel end point. Thus, an event can be avoided in which the SOC is lowered so much that the vehicle 100 is unable to arrive at the destination. The ECU 150 calculates a required SOC successively, based on the distance from a current position of the vehicle 100 to the destination and the electricity mileage of the vehicle 100.

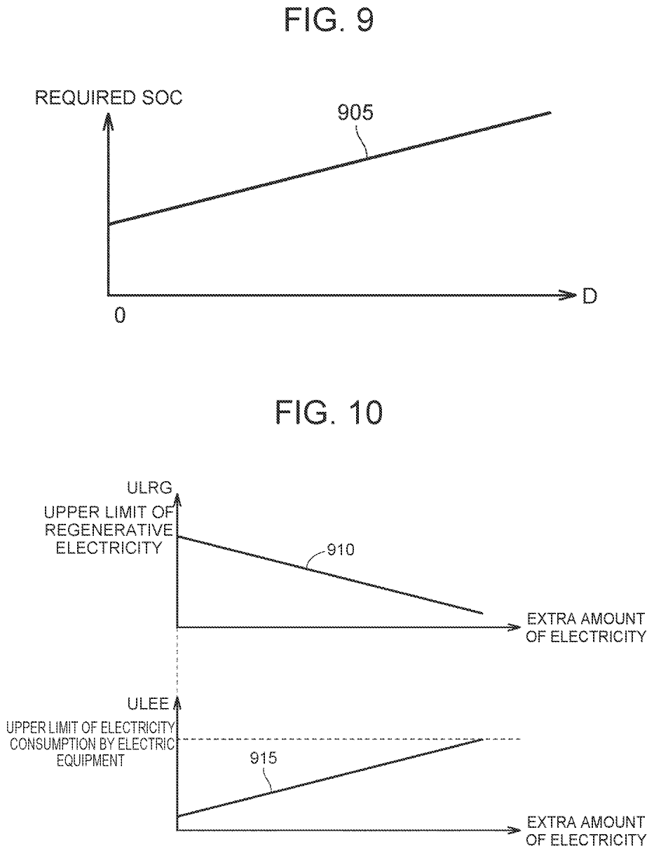

FIG. 9 shows a relationship between the distance from the current position of the vehicle 100 to the destination and the required SOC. A line 905 indicates that the required SOC decreases as the distance D from the current position of the vehicle 100 to the destination decreases (as the vehicle 100 approaches the destination).

FIG. 10 is a diagram for describing relationships between an upper limit of regenerative electricity and an extra amount of electricity, and between an upper limit of electricity consumption by an electric load and the extra amount of electricity.

Referring to FIG. 10, the extra amount of electricity is an amount of electricity corresponding to a value obtained by subtracting a required SOC from a current SOC of the battery 105. The larger the extra amount of electricity is, the larger amount of electricity the MG 135 or an accessory machine 140 can consume additionally before the vehicle 100 arrives at the destination.

A line 910 indicates the relationship between the upper lint ULRG of regenerative electricity and the extra amount of electricity. When the vehicle 100 is braked, the ECU 150 controls the PCU 133 in such a manner that the value of regenerative electricity does not exceed the upper limit ULRG.

The ECU 150 sets the upper limit ULRG in such a manner that the upper limit ULRG becomes higher as the extra amount of electricity decreases. Thus, when the extra amount of electricity is smaller, the battery 105 is allowed to be charged with more regenerative electricity. As a result, it is made easier to prevent the current SOC from falling below the required SOC. In contrast, when the extra amount of electricity is larger, regenerative electricity is more easily decreased. As a result, since it is difficult for the current SOC to increase, it can be made easier to lower the travel end SOC.

A line 915 indicates the relationship between the upper limit ULEE of electricity consumption by an electric load (for example, the MG 135 or any one of the accessory machines 140) and the extra amount of electricity. The ECU 150 controls the electric load in such a manner that electricity consumption by the electric load does not exceed the upper limit ULEE.

The ECU 150 sets the upper limit ULEE in such a way that the upper limit ULEE becomes lower as the extra amount of electricity decreases. Thus, when the extra amount of electricity is small, electricity consumption by the electric load is decreased. As a result, it is difficult for the current SOC to fall below the required SOC. In contrast, when the extra amount of electricity is large, electricity consumption by the electric load easily increases. As a result, since the current SOC easily decreases, it can be made easier to lower the travel end SOC.

In the description above, SOC lowering control is performed in each vehicle 100 that is configured to perform only external charging, of external discharging and external charging. However, SOC lowering control may be performed in a V2G vehicle that is capable of both external discharging and external charging.

For example, when a V2G vehicle does not conclude such an agreement with the aggregator that the V2G vehicle participates in DR by performing external discharging, what the ECU of the vehicle can perform when the V2G vehicle participates in DR is only external charging, of external discharging and external charging. In other words, the V2G vehicle can only receive electricity from the electric power grid PG. In such a case, the ECU of the V2G vehicle may perform SOC lowering control.

In the description above, the electricity facilities 310 are dedicated for external charging. However, an electricity facility may be configured to convert electricity from an electricity resource and supply the electricity after conversion to the electric power grid PG. In other words, the electricity conversion device of the electricity facility may be a bidirectional electricity conversion device. When a vehicle 100, which is V1G, participates in DR by using such an electricity facility, what the ECU 150 can perform is also only external charging, of external discharging and external charging. In such a case, the ECU 150 may perform SOC lowering control.

When a V2G vehicle participates in DR by using an electricity facility 310 dedicated for external charging, what the ECU of the V2G vehicle can perform is also only external charging, of external discharging and external charging. In such a case, the ECU may perform SOC lowering control.

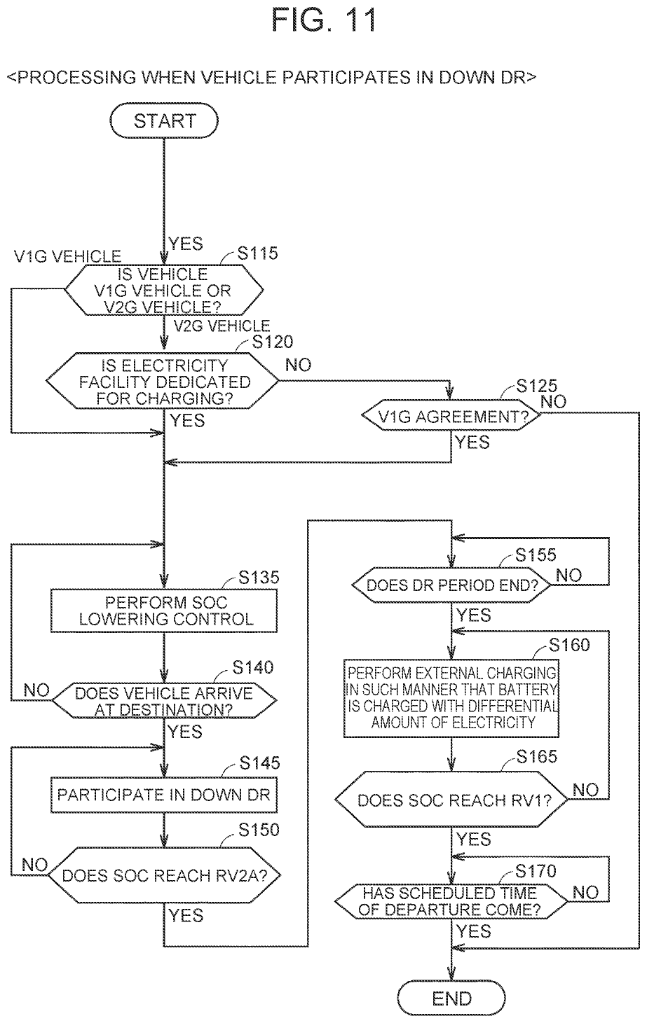

FIG. 11 is a flowchart showing an example of processing performed by the ECU 150 according to the first embodiment. The processing in the flowchart is performed when a vehicle 100 participates in down DR, and is started when the start switch 184 (FIG. 2) is pressed. In a description of the flowchart, it is assumed that a destination of the vehicle 100 has been set. Hereinafter, FIG. 6 is referred to as appropriate.

Referring to FIG. 11, the ECU 150 switches processing, depending on whether the vehicle in which the ECU 150 is mounded is a V1G vehicle or a V2G vehicle (step S115). In the example, since the ECU 150 is mounted in the vehicle 100, which is a V1G vehicle, the ECU 150 advances the processing to step S135. If the ECU 150 is mounted in a V2G vehicle, the ECU 150 advances the processing to step S120.

Next, the ECU 150 determines, according to a signal from the server 600, whether or not an electricity facility 310 (facility for DR participation) that is used for the vehicle 100 to participate in DR is dedicated for external charging (step S120). The server 600 determines whether or not the facility for DR participation is dedicated for external charging, based on information on the facility for DR participation included in an approval signal S11 or an approval signal S21, and on the electricity facility information table 626 (FIG. 4), and sends a result of the determination to the vehicle 100.

When the facility for DR participation is dedicated for external charging (YES in step S120), the ECU 150 advances the processing to step S135. The case where the processing is advanced to step S135 corresponds to a case where the electricity facility 310 is capable of only charging processing, of discharging processing and charging processing as described above. When the facility for DR participation is not dedicated for external charging, that is, when the facility for DR participation is capable of both external charging and external discharging (NO in step S120), the ECU 150 advances the processing to step S125.

Next, the ECU 150 determines whether or not a user of the vehicle in which the ECU 150 is mounted has concluded a V1G agreement as described above with the aggregator (step S125). The ECU 150 performs the determination process, based on agreement information stored in the storage device 176. When a V1G agreement is not concluded (NO in step S125), the ECU 150 terminates the processing in FIG. 11. When a V1G agreement is concluded (YES in step S125), the ECU 150 advances the processing to step S135.

Next, the ECU 150 performs SOC lowering control, following start of travel of the vehicle 100 (step S135). The ECU 150 performs SOC lowering control to an extent that the SOC does not become less than a required SOC.

Next, the ECU 150 determines whether or not the vehicle 100 arrives at the destination as a travel end point (step S140). The ECU 150 performs the determination process, based on a result of detection by the location device 178. When the vehicle 100 does not arrive at the destination (NO in step S140), the ECU 150 performs SOC lowering control until the vehicle 100 arrives at the destination. When the vehicle 100 arrives at the destination (YES in step S140), the ECU 150 advances the processing to step S145. The SOC at the destination (travel end SOC) is X1 (<X0).

Next, with the connector 325 of the electricity cable 320 of an electricity facility 310 (FIG. 3) in a state of being connected to the inlet 110 of the vehicle 100, when a DR period (for example, period P22) comes, the ECU 150 causes the vehicle 100 to participate in down DR during the DR period (step S145). When the amount of charge of the battery 105 during the period is zero, such a case corresponds to the case B1 in FIG. 6. When the amount of charge is not zero, such a case corresponds to the case B2 in FIG. 6.

Next, the ECU 150 determines whether or not the SOC reaches RV2A (step S150). When the SOC does not reach RV2A (NO in step S150), the ECU 150 keeps the vehicle 100 participating in down DR by performing external charging until the SOC reaches RV2A. When RV2A is equal to X1 (the case B2 in FIG. 6), external charging is not performed. When the SOC reaches RV2 (YES in step S150), the ECU 150 advances the processing to step S155.

Next, the ECU 150 determines whether or not the DR period ends, based on the agreement information stored in the storage device 176 (step S155). When the DR period does not end (NO in step S155), the ECU 150 performs the determination process until the DR period ends. When the DR period ends (YES in step S155), the ECU 150 advances the processing to step 5160.

Next, the ECU 150 performs external charging in such a manner that the battery 105 is charged with a differential amount of electricity by a time (for example, time t29) prior to a scheduled time of departure of the vehicle 100 (step S160).

Next, the ECU 150 determines whether or not the SOC reaches RV1 (step S165). When the SOC does not reach RV1 (NO in step S165), the ECU 150 continues external charging until the SOC reaches RV1. When the SOC reaches RV1 (YES in step S165), the ECU 150 finishes external charging and advances the processing to step S170.

Next, the ECU 150 determines whether or not the scheduled time of departure of the vehicle 100 (for example, time t30) has come (step S170). When the scheduled time of departure has not come (NO in step S170), the ECU 150 performs the determination process until the scheduled time of departure comes. When the scheduled time of departure has come (YES in step S170), the ECU 150 terminates the processing in FIG. 11.

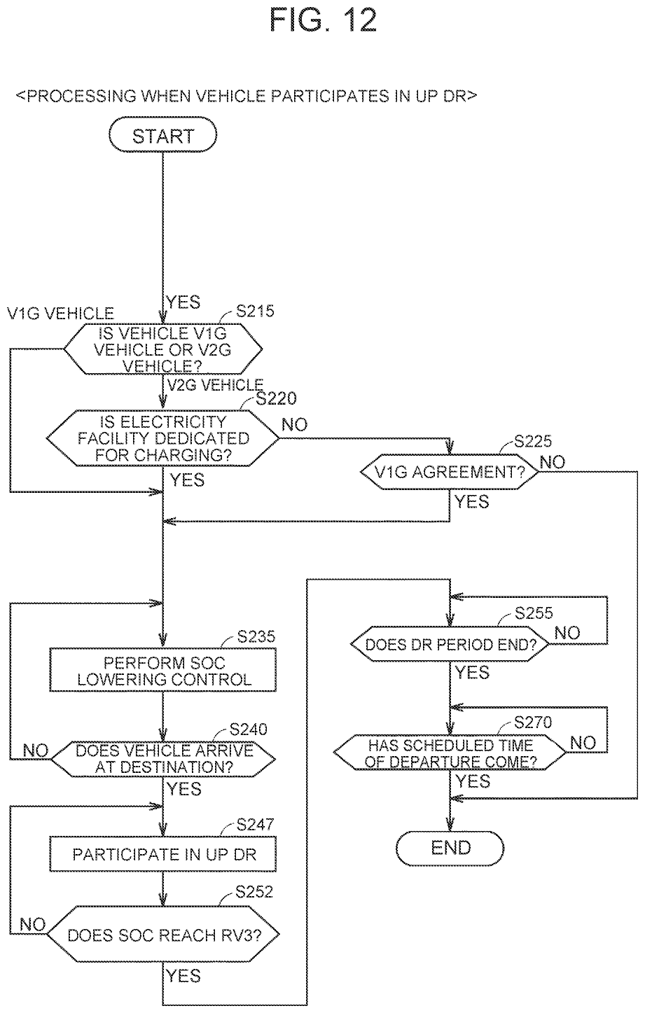

FIG. 12 is a flowchart showing another example of processing performed by the ECU 150 according to the first embodiment. The processing in the flowchart is performed when a vehicle 100 participates in up DR, and is started when the start switch 184 is pressed. In a description of the flowchart, it is assumed that a destination of the vehicle 100 has been set.

The flowchart is different from the flowchart in FIG. 11, in a point that processes corresponding to steps S160, S165 are omitted. On the other hand, processes in steps S215 to S255, S270 are similar to the processes in steps S115 to S155, S170 in FIG. 11, respectively.

In the embodiment, a vehicle 100, which is a V1G vehicle, is mainly used for an electricity resource. Thus, while the configuration and control of the vehicle are more simplified than when a V2G vehicle is used for an electricity resource, contribution to adjustment of electricity supply-demand balance can be achieved.

Alternatively, when a V2G vehicle is used for an electricity resource, the vehicle can appropriately participate in DR while dealing with a situation where only external charging, of external charging and external discharging, is possible. Specifically, even in such a situation, SOC lowering control is performed in the V2G vehicle, and the travel end SOC is lowered to X1 (<X0). As a result, the V2G vehicle can contribute to adjustment of electricity supply-demand balance more than when SOC lowering control is not performed.

The ECU 150 may perform SOC lowering control, without acquiring information on electricity supply-demand balance (for example, from the server 600). Thus, the vehicle 100 can be used exclusively for DR, while the processing by the ECU 150 is simplified.

Modification 1 of First Embodiment

Although the ECU 150 is configured to perform SOC lowering control while the vehicle 100 is traveling in the first embodiment, the ECU 150 may perform SOC lowering control before the vehicle 100 starts traveling (while the vehicle is stopped).

Specifically, SOC lowering control may be control of an accessory machine 140 that is performed in such a manner that when the vehicle 100 participates in DR at a travel end point (destination), operation of the accessory machine 140 is started before a scheduled time of travel start of the vehicle 100. In such a modification 1, the scheduled time of travel start is a time at which the vehicle 100 starts traveling before time t20 in FIG. 6, and is set, for example, by using the HMI device 182. Hereinafter, the control by the ECU 150 as described above is also referred to as pre-operation control.

The pre-operation control in a case where the air-conditioning device 144 operates is also referred to as pre-air-conditioning control. The pre-air-conditioning control is control of causing the air-conditioning device 144 to operate a predetermined period of time (for example, 10 minutes) before the scheduled time of travel start of the vehicle 100, in order to adjust temperature in the vehicle cabin of the vehicle 100 to an appropriate temperature at the scheduled time of travel start.

The pre-operation control in a case where the battery heater 142 operates is also referred to as pre-battery-heating control. The pre-battery-heating control is control of causing the battery heater 142 to operate a predetermined period of time before the scheduled time of travel start, in order to adjust temperature of the battery 105 to an appropriate temperature at the scheduled time of travel start.

For example, whether or not to perform the pre-operation control, the scheduled time of travel start, the predetermined period of time, the appropriate temperature, and a beginning time of the pre-operation control are set (reserved) by a user using the HMI device 182.

When the pre-operation control is performed, electricity consumption by the accessory machines 140 can be made higher than when the pre-operation control is not performed. As a result, it can be made easier to lower the SOC of the battery 105, while a user immediately enjoys the function of an accessory machine at the scheduled time of travel start at which the user is thought to ride the vehicle 100.

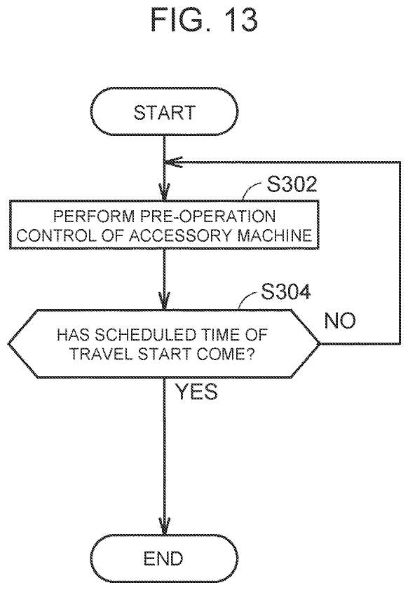

FIG. 13 is a flowchart showing an example of processing performed by the ECU 150 according to the modification 1. The processing in the flowchart is performed when a vehicle 100 participates in DR, and is started when the beginning time of the pre-operation control comes.

Referring to FIG. 13, the ECU 150 performs the pre-operation control of an accessory machine such as the battery heater 142 or the air-conditioning device 144 (step S302).

Next, the ECU 150 determines whether or not the scheduled time of travel start of the vehicle 100 has come (step S304). When the scheduled time of travel start has not come (NO in step S304), the ECU 150 continues the pre-operation control of the accessory machine until the time comes. When the time has come (YES in step S304), the ECU 150 terminates the processing in FIG. 13.

Modification 2 of First Embodiment The ECU 150 may start SOC lowering control while the vehicle 100 is traveling when a preceding time, which is a threshold period of time before a scheduled time of travel end of the vehicle 100, comes.

With such a configuration, SOC lowering control is not performed before the preceding time comes. As a result, an event can be avoided in which the SOC of the battery 105 is unnecessarily lowered before the preceding time comes (for example, an event in which the SOC is lowered so much that the vehicle 100 becomes unable to travel).

The threshold period of time is stored in the storage device 176, for example, as a value that is set by the user using the HMI device 182 such that the preceding time comes immediately before the scheduled time of travel end, or as a default value (for example, 10 minutes).

The ECU 150 may start SOC lowering control when the distance from the vehicle 100 to the destination decreases to a threshold distance (for example, a predetermined distance such as three kilometers) while the vehicle 100 is traveling.

With such a configuration, SOC lowering control is not performed before the distance from the vehicle 100 to the destination decreases to the threshold distance. Thus, an event can be avoided in which the SOC of the battery 105 is unnecessarily lowered.

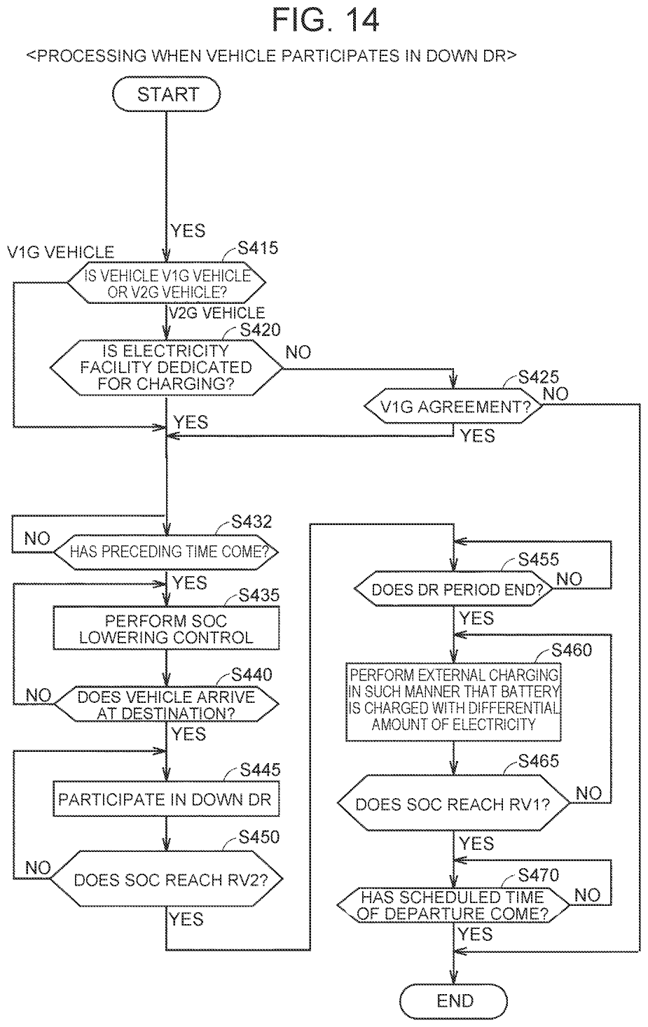

FIG. 14 is a flowchart showing an example of processing performed by the ECU 150 according to such a modification 2. The processing in the flowchart is performed when a vehicle 100 participates in down DR, and is started when the start switch 184 is pressed. In a description of the flowchart, it is assumed that a destination of the vehicle 100 has been set.

Referring to FIG. 14, the flowchart is different from the flowchart in FIG. 11, in a point that a process in step S432 is added. Processes in steps 5415 to S425, S435 to S470 are similar to the processes in steps S115 to S125, S135 to S170 in FIG. 11, respectively.

The ECU 150 determines whether or not the preceding time has come (step S432). The ECU 150 performs the determination process, based on agreement information and information indicating the threshold period of time that are stored in the storage device 176. When the preceding time has not come (NO in step S432), the ECU 150 performs the determination process until the preceding time comes. When the preceding time has come (YES in step S432), the ECU 150 advances the processing to step

S435, and starts SOC lowering control.

The flowchart shows an example in which the vehicle 100 participates in down DR. In contrast, when the vehicle 100 participates in up DR, the ECU 150 may start SOC lowering control, in response to coming of the preceding time.

Second Embodiment

Although a destination of a vehicle 100 is set by a user in the first embodiment and the modifications 1, 2 thereof, a destination of a vehicle 100 may be predicted by the ECU 150, based on a history of user behavior.

Specifically, the ECU 150 is configured to predict a plurality of candidates of the destination, based on the history of user behavior stored in the storage device 176. Hereinafter, a candidate for the destination is also referred to as “candidate destination”.

In a second embodiment, the ECU 150 determines the required SOC, based on a SOC of the battery 105 that is required for the vehicle 100 to travel up to each candidate destination. To facilitate a description below, a case is described where the number of candidate destinations is two.

A hardware configuration and a procedure of control of each vehicle 100 according to the second embodiment are similar to the hardware configuration and the procedure of control of each vehicle 100 according to the first embodiment, respectively, unless otherwise stated.

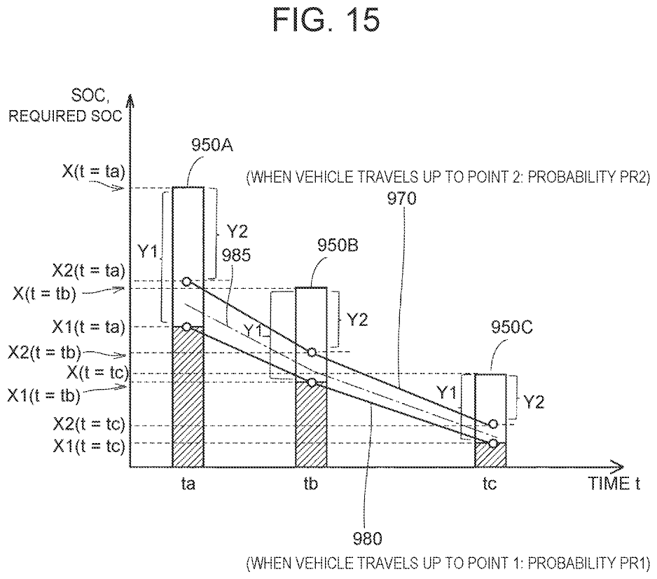

FIG. 15 is a diagram for describing how the required SOC is determined when the number of candidate destinations is two.

Referring to FIG. 15, a vertical axis represents the SOC of the battery 105, and a horizontal axis represents time. In the example, a point 1 and a point 2 are candidate destinations. The ECU 150 predicts that the probability of the point 1 being the destination is a probability PRI, and the probability of the point 2 being the destination is a probability PR2 (A+B=100 [%]). The probabilities PRI, PR2 can change over time while the vehicle 100 is traveling. The distance from the vehicle 100 to the point 2 is longer than the distance from the vehicle 100 to the point 1. In other words, the point 2 is farther than the point 1 from the vehicle 100.

Bar graphs 950A, 950B, 950C represent SOCs at times ta, tb, tc, respectively, and indicate that the SOC decreases as the vehicle 100 travels more. Lines 980, 970 indicate changes over time in SOCs required for the vehicle 100 to travel up to the points 1, 2, respectively. A line 985 indicates the required SOC of the battery 105 in the second embodiment.

For example, at each of times ta, tb, tc, the SOC of the battery 105 is represented by X. The SOC required for the vehicle 100 to travel up to the point 1 of the two candidate destinations (hereinafter, also referred to as the first required SOC) is X1. When the destination of the vehicle 100 is the point 1, the extra amount of electricity is an amount of electricity corresponding to Y1. In such a case, the ECU 150 can perform SOC lowering control in such a manner that the extra amount of electricity is consumed by an electric load before the vehicle 100 arrives at the point 1.

The SOC required for the vehicle 100 to travel up to the point 2 of the two candidate destinations (hereinafter, also referred to as the second required SOC) is X2. When the destination of the vehicle 100 is the point 2, the extra amount of electricity is an amount of electricity corresponding to Y2. In such a case, the ECU 150 can perform SOC lowering control in such a manner that the extra amount of electricity is consumed by an electric load before the vehicle 100 arrives at the point 2.

As described above, when both the points 1, 2 are candidate destinations, the ECU 150 determines the required SOC (line 985), based on the first required SOC (line 980) and the second required SOC (line 970). For example, while the vehicle 100 is traveling, the ECU 150 may calculate a sum of a value obtained by multiplying the first required SOC and the probability PR1 and a value obtained by multiplying the second required SOC and the probability PR2, and may determine the sum as the required SOC.

In such a case, the required SOC is within a range of values that are more than the first required SOC and less than the second required SOC. If the required SOC is thus determined, both the first required SOC and the second required SOC are reflected in the determination of the required SOC. As a result, when the vehicle 100 travels up to the point 2, an event can be avoided in which the SOC of the battery 105 excessively lowers.

The ECU 150 may determine a required SOC in such a manner that the required SOC becomes equal to the second required SOC. Thus, an event can be avoided in which the SOC of the battery 105 lowers so much that the vehicle 100 becomes unable to arrive at the point 2.

The history of user behavior of the vehicle 100 may be sequentially sent to the server 600 via the communication device 180 of the vehicle 100 and stored in the storage device 620 of the server 600. When the ECU 150 predicts a plurality of candidate destinations, the ECU 150 may acquire the history of user behavior from the server 600, and may calculate a required SOC as described above, based on a result of the acquisition.

The ECU 150 may determine a scheduled time of travel end, based on the history of user behavior. For example, the ECU 150 may determine, as the scheduled time of travel end, a time in a time period of day in which the vehicle 100 finishes traveling more frequently (for example, a time period of day in which the user comes home more frequently) than in other time periods of day. The ECU 150 may acquire information on traffic congestion on a route along which the vehicle 100 travels from an external server via the communication device 180, and may determine the scheduled time of travel end by using a result of the acquisition.

Other Modifications

The vehicle 100 may be a hybrid electric vehicle (HEV) further equipped with an internal combustion engine.

The DR period is not limited to period P22 (FIG. 6), and may be any period of periods after time t20 and before time t30. Similarly, the period during which the battery 105 is charged with the differential amount of electricity is not limited to period P23 if the period is after a down DR period and before time t30.

The ECU 150 may temporarily suspend SOC lowering control when the SOC becomes less than the required SOC while the SOC lowering control is being performed. Thereafter, for example, when the battery 105 is charged through regenerative electricity generation and the SOC increases, the ECU 150 may resume the SOC lowering control.

The HMI device 182 may inquire of the user whether or not the user desires SOC lowering control. When a user operation indicating that the user desires SOC lowering control is performed by using the HMI device 182, the ECU 150 performs SOC lowering control as described above. The ECU 150 may be configured not to perform SOC lowering control when such a user operation is not performed. Thus, when the vehicle 100 does not participate in DR at a travel end point (for example, when no electricity facility 310 is installed at the point), lowering of the SOC can be avoided.

The server 600 may remotely control external charging during the DR period. For example, with the connector 325 (FIG. 3) in a state of being connected to the inlet 110, when the DR period for the vehicle 100 comes, the server 600 may control the electricity facility 310 in such a manner that external charging is performed. In such a case, the server 600 arranges a schedule of external charging, according to the resource management information table 625 (FIG. 6).

The disclosed embodiments, in all respects, shall be construed as illustrative and not as restrictive. The scope of the disclosure is defined not by the description but by claims, and is intended to include equivalent meanings to the claims and all modifications made within the scope.

What is claimed is:

1. A vehicle that is capable of participating in demand response (DR) for adjustment of electricity supply-demand balance in an electric power grid, the vehicle comprising:
an electric load;
an electricity reception device configured to receive electricity from the electric power grid via an electricity facility installed outside of the vehicle;
an electricity storage device that stores the electricity received by the electricity reception device; and
a control device that controls the electric load and charging of the electricity storage device,
wherein the control device is configured to perform external charging that charges the electricity storage device by using the electricity reception device,
the DR includes down DR that requests that the vehicle decrease an amount of charge of the electricity storage device in the external charging when the vehicle participates in the DR, and
the control device performs SOC lowering control that controls the electric load in such a manner that when the vehicle participates in the down DR at a travel end point of the vehicle where the electricity facility is installed, a travel end SOC becomes lower than when the vehicle does not participate in the down DR at the travel end point, the travel end SOC being a SOC of the electricity storage device at the travel end point.

2. The vehicle according to claim 1, wherein:
when the vehicle does not participate in the down DR at the travel end point during a first period, the amount of charge in the external charging during the first period is a first amount of charge; and
when the vehicle participates in the down DR at the travel end point during the first period,
the amount of charge in the external charging during the first period is a second amount of charge that is smaller than the first amount of charge, and
the control device performs the external charging in such a manner that the electricity storage device is charged with a differential amount of electricity during a second period from an end time of the first period to a scheduled time of departure of the vehicle, the differential amount of electricity being an amount of electricity corresponding to a difference between the first amount of charge and the second amount of charge.

3. The vehicle according to claim 1, wherein:
the DR includes up DR that requests that the vehicle increase the amount of charge in the external charging, and
the SOC lowering control includes control of the electric load that is performed in such a manner that when the vehicle participates in the up DR at the travel end point, the travel end SOC becomes lower than when the vehicle does not participate in the up DR at the travel end point.

4. The vehicle according to claim 1, wherein:
the electric load includes a rotating electric machine that generates driving force for travel of the vehicle by consuming the electricity stored in the electricity storage device; and
the SOC lowering control includes control of the rotating electric machine that is performed in such a manner that when the vehicle participates in the DR at the travel end point, an upper limit of output produced by the rotating electric machine during travel of the vehicle becomes higher than when the vehicle does not participate in the DR at the travel end point.

5. The vehicle according to claim 1, wherein:
the control device controls the electric load during travel of the vehicle in such a manner that SOC of the electricity storage device does not become less than a required SOC; and
the required SOC is a SOC of the electricity storage device that is required for the vehicle to travel up to a destination of the vehicle as the travel end point.

6. The vehicle according to claim 5, wherein:
the control device is configured to predict a plurality of candidates for the destination;
the required SOC is determined based on a first required SOC and a second required SOC;
the first required SOC is a SOC of the electricity storage device that is required for the vehicle to travel up to a first candidate among the plurality of candidates for the destination; and
the second required SOC is a SOC of the electricity storage device that is required for the vehicle to travel up to a second candidate among the plurality of candidates for the destination, the second candidate having a longer distance from the vehicle than the first candidate.

7. The vehicle according to claim 1, wherein:
the electric load includes an accessory machine that operates by consuming the electricity stored in the electricity storage device; and
the SOC lowering control includes control of the accessory machine that is performed in such a manner that when the vehicle participates in the DR at the travel end point, electricity consumption by the accessory machine increases, compared to when the vehicle does not participate in the DR at the travel end point.

8. The vehicle according to claim 1, wherein:
the electric load includes an accessory machine that operates by consuming the electricity stored in the electricity storage device; and
the SOC lowering control includes control of the accessory machine that is performed in such a manner that when the vehicle participates in the DR at the travel end point, the accessory machine starts operating before a scheduled time of travel start of the vehicle.

9. The vehicle according to claim 1, wherein:
the electric load includes a generator that is configured to perform regenerative electricity generation in connection with braking of the vehicle;
regenerative electricity that is electricity generated by the regenerative electricity generation is supplied from the generator to the electricity storage device; and
the SOC lowering control includes control of the generator that is performed in such a manner that when the vehicle participates in the down DR at the travel end point, the regenerative electricity during travel of the vehicle is decreased, compared to when the vehicle does not participate in the down DR at the travel end point.

10. The vehicle according to claim 1, wherein the control device starts the SOC lowering control when a preceding time comes, the preceding time being a time a threshold period of time before a scheduled time of travel end that is a time at which the vehicle is scheduled to arrive at the travel end point.

11. The vehicle according to claim 1, wherein the control device starts the SOC lowering control when a distance from the vehicle to the travel end point decreases to a threshold distance.

12. The vehicle according to claim 1, wherein the control device performs the SOC lowering control when the electricity facility is able to perform, of discharging processing and charging processing, only the charging processing, the discharging processing causing the electricity stored in the electricity storage device to be discharged into the electric power grid via the electricity facility, the charging processing causing the control device to perform the external charging by using electricity from the electric power grid.

13. The vehicle according to claim 1, wherein the vehicle includes a V1G vehicle configured to perform only the external charging, of external discharging and the external charging, the external discharging discharging the electricity stored in the electricity storage device into the electric power grid via the electricity facility.
